(19) United States
(12) Patent Application Publication
(10) Pub. No.: US 2007/0269260 A1
(43) Pub. Date: Nov. 22, 2007

(54) Toothbrush With Means for Attaching a Toothpaste Tube

(76) Inventor: David Kirby, Huntington, WV (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/419,046

(22) Filed: May 18, 2006

(51) Int. Cl. A46B 11/04; A47L 13/22; B43M 11/06

(52) U.S. Cl. 401/280; 401/183; 401/270

(57) ABSTRACT

A toothbrush coupled to a tube of toothpaste is disclosed, the toothbrush comprising a head depending from an elongated stem. The head comprises a plurality of bristles and at least one toothpaste dispensing port. The head also includes at least one restraint to open and close the port(s). The stem comprises an opening coupled to the tube, and wherein the stem further comprises a channel extending from the opening to the port(s). In the present embodiment, the restraint comprises at least one plug that is inserted into and removable from the port(s).

### RELATED U.S. APPLICATION DATA

Not applicable.

### BACKGROUND OF THE INVENTION

1. Field of the Invention

The present invention, generally, relates to brushing, scrubbing and cleaning devices for the teeth and, more particularly, to a new and improved toothbrush that may be threadably coupled to a commercially available toothpaste tube.

2. Description of the Related Art

There have been numerous attempts to improve upon the form and function of the toothbrush. In particular, there have been numerous inventions devoted to providing combinations of toothbrush and toothpaste, including integral units in which the toothpaste is inserted into the toothbrush and stored therein until the toothpaste supply is exhausted. Many of these devices or apparatuses include an outlet or outlets for dispensing the toothpaste onto or adjacent the bristles of the toothbrush. However, the prior art fails to effectively address the need for having an outlet(s) or port(s) that has means for closing the outlet(s) or port(s) after the toothpaste is extruded therethrough. The present invention fulfills this need.

Of the many prior art publications, including issued patents, the following devices and apparatuses are considered the most relevant to the present invention and are considered exemplary of the prior art. For instance, U.S. Pat. No. 5,028,158 discloses a toothbrush with means for attaching a toothpaste tube to an end of the toothbrush. The toothbrush portion has an enlarged and cylindrical end with internal threads for receiving the external threads from the neck of a toothpaste tube. After attachment, the toothpaste is extruded through at least one port in the head of the toothbrush subjacent to the bristles. The apparatus further includes enclosures for the toothbrush portion and the attached toothpaste tube portion. Similarly, U.S. Pat. No. 2,900,650 and U.S. Pat. No. 5,244,298, respectively, disclose similar apparatuses utilizing commercially available tubes of toothpaste that are attached to the toothbrush portion for extrusion of the toothpaste onto the bristles. U.S. Pat. 2,900,650 provides enclosures for both the toothbrush and the toothpaste tube, while U.S. Pat. 5,244,298 provides an enclosure for the toothpaste tube only. In addition, U.S. Pat. No. 5,908,257 and U.S. Pat. No. 6,481,910, respectively, each disclose toothpaste dispensing toothbrushes having an enclosure for the head portion of the toothbrush.

However, each of the aforementioned references fail to disclose a toothbrush having at least one port that is obstructed by a restraint in the head of the toothbrush. Several of the references fail to address this problem altogether, while a few of the patents address the problem via the use of a general enclosure for the head, rather than a direct obstruction to the port(s). Thus, as to this element, the present invention is patentably distinguishable of the prior art.

Another reference considered relevant is U.S. Pat. No. 5,746,532, which discloses a toothbrush assembly having one or several outlets for extrusion of the toothpaste onto the bristles of the toothbrush. In particular, and as depicted in FIG. 10 and FIG. 12 therein, the outlets have valve segments (76) that are biased toward a closed position (see FIG. 12) when toothpaste is not forced through the outlets. However, this is not a satisfactory solution in the attempted prevention of crusting, exposure and/or waste of toothpaste housed within the toothbrush apparatus. In particular, structural failure of the material after repeated usage seems to be typical of devices of this type such that incomplete closure results and the crusting and/or drying of the toothpaste occurs. The present invention does not suffer from such a problem, relying on common and reliable mechanical elements to open and close the port(s) as desired.

Similarly, U.S. Pat. No. 5,846,010 discloses a toothpaste dispensing toothbrush that includes a valve for opening and closing the channel through which the toothpaste is carried toward the outlet(s) of the toothbrush. The valve includes an aperture (48) through which the toothpaste passes by the valve. However, this configuration seems especially susceptible to crusting of toothpaste within the aperture, and therefore, presents the potential for blockage of the channel and/or the outlet(s), or by extruding a crusted section of toothpaste onto the bristles. Most people do not like the texture of crusted toothpaste in their mouths during brushing, and the effectiveness of the paste may be marginal.

In light of the aforementioned references, there is an apparent need for a toothbrush that is capable of being coupled to a toothpaste tube commonly available in which the toothpaste is extruded and delivered onto the bristles of the toothbrush through at least one port, and having a restraint for opening and closing the port(s) in a reliable and easy manner. The present invention provides such a device. Furthermore, an adapter may be included with the present invention to solve the problem of differently dimensioned tube necks, a problem and solution not accounted for in the aforementioned references. As such, the present invention is patentably distinct over the prior art and an improvement in overall performance when compared to the devices known in the art

### SUMMARY OF THE INVENTION

In one embodiment of the present invention, a toothbrush coupled to a tube of toothpaste is disclosed, the toothbrush comprising a head depending from an elongated stem. The head comprises a plurality of bristles and at least one toothpaste dispensing port. The head also includes at least one restraint to open and close the port(s). The stem comprises an opening coupled to the tube, and wherein the stem further comprises a channel extending from the opening to the port(s). In the present embodiment, the restraint comprises at least one plug that is inserted into and removable from the port(s).

In another embodiment of the present invention, and somewhat similarly to the previously described embodiment, a toothbrush coupled to a tube of toothpaste is disclosed, the toothbrush comprising a head depending from an elongated stem. The head comprises a plurality of bristles and at least one toothpaste dispensing port. The head includes at least one selectively openable restraint to open and close the port(s). The stem comprises an opening coupled to the tube, wherein the stem further comprises a channel extending from the opening to the port(s).

In this embodiment, each restraint provided is selectively openable, and wherein the restraint comprises a movable element. The movable element may comprise a body coupled to a button, the body movable in response to engagement of the button. The body covers the port at a first position of the button, and correspondingly, the body uncovers or exposes the port at a second position. The button may be biased to return to the first position.

Furthermore, and in this present embodiment, the movable element may comprise a slidable element. The slidable element may comprise a body engaging a track, and wherein the body may be slidably movable along the track between a first position and a second position. The body covers the port at the first position, and correspondingly, the body uncovers or exposes the port at the second position. The body may further comprise means for slidably moving the body.

In regard to the aforementioned embodiments described above, it is envisioned that the embodiments may include the alternatives or additions described here, including a grip for the stem, wherein the grip may be an ergonomic and comfortable grip. Furthermore, it is envisioned that an adapter may be included and utilized to couple an unconventionally sized neck to the opening of the stem.

In another embodiment of the present invention, a toothbrush kit is disclosed, the toothbrush kit comprising at least one tube of toothpaste. The toothbrush includes the embodiments disclosed previously, and comprises a head depending from an elongated stem. The head comprises a plurality of bristles and at least one toothpaste dispensing port. The head comprises at least one restraint to open and close the port(s). The stem comprises an opening coupled to the tube of toothpaste, and wherein the stem further comprises a channel extending from the opening to the port(s).

As discussed above, the device of the present invention overcomes the disadvantages inherent in the prior art devices. In this respect, before explaining at least one embodiment of the present invention in detail, it is to be understood that the invention is not limited in its application to the details of construction and to the arrangement of the components or elements set forth in the following description or as illustrated in the drawings. The invention is capable of other embodiments and of being practiced and carried out in various ways. Also, it is to be understood that the phraseology and terminology employed herein are for the purpose of description and should not be regarded as limiting the scope of the invention.

Accordingly, those skilled in the art will appreciate that the conception upon which this invention is based may readily be utilized as a basis for the design of other structures, methods, and systems for carrying out the purpose or purposes of the present invention. Therefore, it is important that the claims be regarded as including such equivalent constructions insofar as they do not depart from the spirit of the present invention.

Furthermore, the purpose of the foregoing “Abstract” is to enable the U.S. Patent and Trademark Office and the public, generally, and especially including the practitioners in the art who are not familiar with patent or legal terms or phraseology, to determine quickly from a cursory inspection, the nature and essence of the technical disclosure of the application. The “Abstract” is neither intended to define the invention of the application, nor is it intended to be limiting to the scope of the invention in any way. It is intended that the application is defined by the claims appended to this application.

### BRIEF DESCRIPTION OF THE DRAWINGS

Additional utility and features of the invention will become more fully apparent to those skilled in the art by reference to the following drawings, which illustrate the primary features of the preferred embodiment and numerous alternative embodiments.

FIG. 1 is a perspective view of a toothbrush comprising an opening with threads for coupling to a neck of a tube of toothpaste;

FIG. 2 is a perspective view of an alternative embodiment of FIG. 1 comprising an opening with a returnably resilient perimeter for impingement about the neck of the tube of toothpaste;

FIG. 3 is a perspective view of the toothbrush comprising an ergonomic grip;

FIG. 4 is a sectional view of the toothbrush taken along line IV-IV of FIG. 1;

FIG. 5 is a sectional view of the toothbrush head taken along line V-V of FIG. 3;

FIG. 6 is a sectional view of the toothbrush head taken along line VI-VI of FIG. 5;

FIG. 7 is a sectional view of the toothbrush head taken along line VII-VII of FIG. 3;

FIG. 8 is a sectional view of the toothbrush head taken along line VIII-VIII of FIG. 7;

FIG. 9 is a perspective view of another embodiment of the toothbrush head having a port with a plug as a restraint to open and close the port;

FIG. 10 is a top view of the port having one embodiment of a button activated body for moving the body from point “A” to point “B” for opening and closing the port;

FIG. 11 is a top view of the port having another embodiment of a button activated body for moving the body from point “A” to point “B” for opening and closing the port;

FIG. 12 is a top view of the port having another embodiment of a wing and lever activated body for moving the body from point “A” to point “B” for opening and closing the port;

FIG. 13 is a perspective view of one embodiment of an adapter; and

FIG. 14 is a perspective view of another embodiment of the adapter.

### DETAILED DESCRIPTION OF THE PREFERRED EMBODIMENT

The detailed description set forth below is for preferred embodiments and is intended to explain the present invention. It is to be understood that a variety of other arrangements are also possible without departing from the spirit and scope of the present invention.

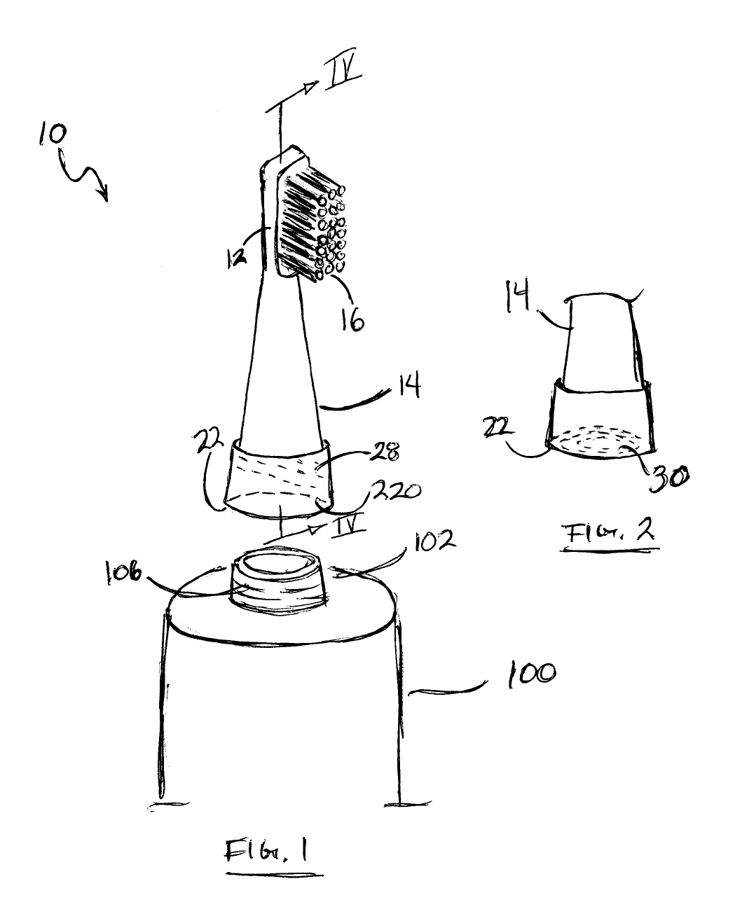

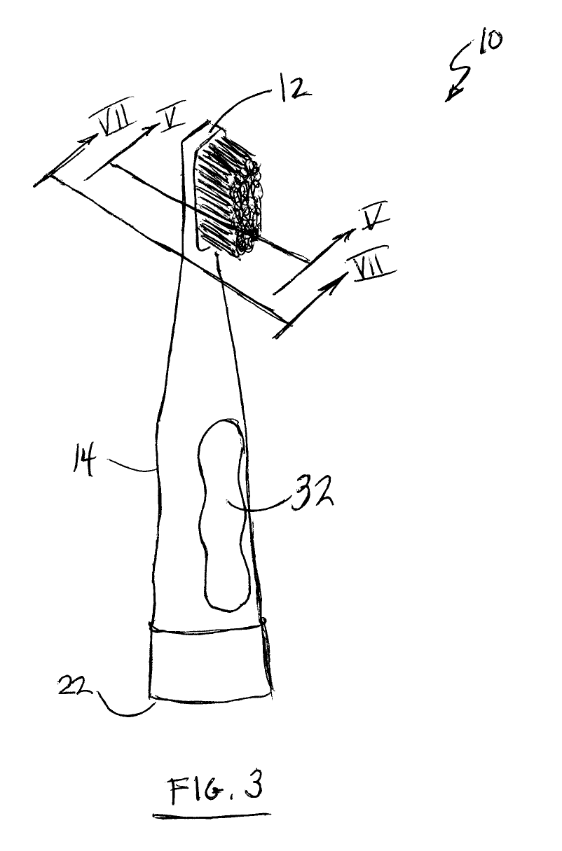

Referring now to FIG. 1, FIG. 3 and FIG. 4, a toothbrush 10 coupled to a tube of toothpaste 100 is described and depicted in accordance with at least one embodiment of the present invention. The toothbrush 10 comprises a head 12 depending from an elongated stem 14. The head 12 comprises a plurality of bristles 16 and at least one toothpaste dispensing port 18. The port 18 includes at least one restraint 20 to open and close the port(s) 18. The stem 14 comprises an opening 22 coupled to the tube 100, with the stem 14 further comprising a channel 24 longitudinally extending from the opening 22 to the port(s) 18, thus communicating the toothpaste from the tube 100 to the head 12, generally, and to the bristles 16, particularly.

The head 12 may comprise a variety of configurations and/or forms, including various geometries to accommodate a plurality of bristles 16 configured for optimum cleansing and brushing, such as the configurations more common in the commercially available toothbrushes that possess multiple rows and/or columns of bristle bundles, including bristle bundles of substantially similar length and bristle bundles having variable lengths so as to form an angled bristle bundle. The head 12 may be substantially planar and parallel to one longitudinal axis of the stem 14, or the head 12 may be angled or deflected from one longitudinal axis so as to provide easier access and brushing coverage to the user's back teeth (as is now commercially available and popular).

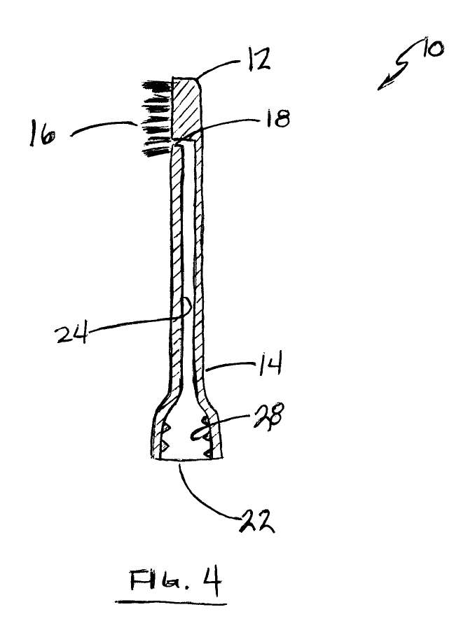

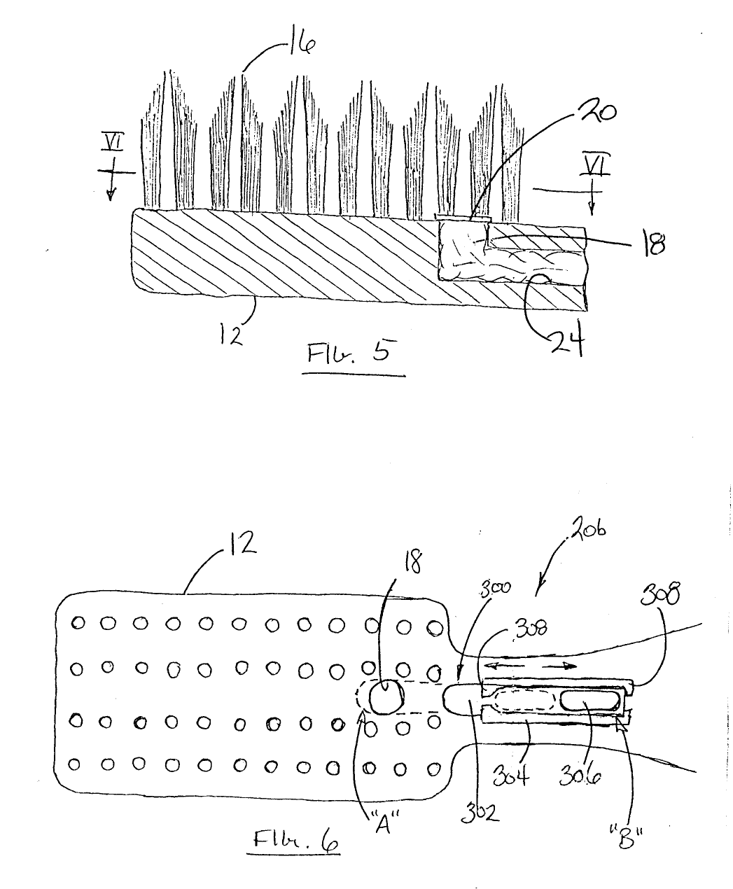

As depicted in FIG. 5 and FIG. 6, the head 12 comprises at least one port 18 formed in the head 12 to extrude toothpaste onto or adjacent with the bristles 18 of the head 12. The port 18 may be placed at a variety of positions along the head 12 of the toothbrush 10. It is envisioned that the head 12 may comprise a plurality of ports 18 (see FIG. 7 and FIG. 8) formed in the head 12 to extrude toothpaste onto or adjacent with the bristles 18, with enhanced distribution of toothpaste across or within the bristles 18. The port(s) 18 may be configured substantially perpendicular to an axis of the head 12 so that toothpaste is extruded substantially perpendicular to the head 12. It is also envisioned that the port(s) 18 may be configured at an angle between perpendicular and parallel to the head 12 so that toothpaste is extruded along and within the bristles 16 at an angle between perpendicular and parallel to the head 12 so as to provide greater coverage within or over the bristles 16.

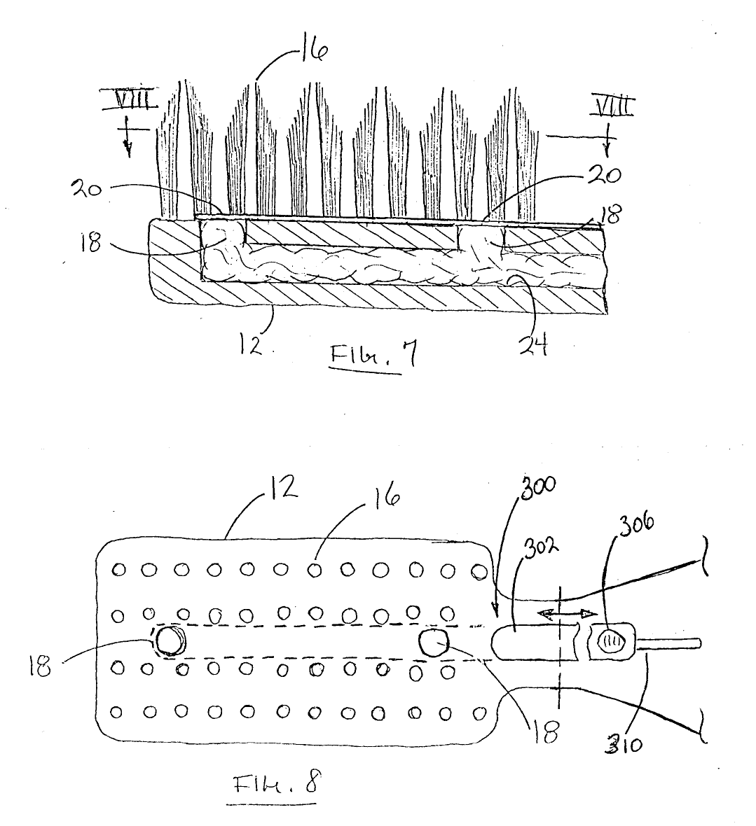

Referring now to FIG. 9 through FIG. 12, generally, the restraint(s) 20 may have a variety of configurations and/or forms to obstruct the exit of the port(s) 18. The restraint(s) 20 function to preserve the freshness and quality of the toothpaste contained in the tube 100 coupled to the toothbrush 10. Thus, in one embodiment, the restraint(s) 20 may be selectively movable (such as by placement or insertion) into or about the port(s) 18 to provide egress of the toothpaste for extrusion therethrough. In another envisioned embodiment, the restraint(s) 20 may be selectively openable so as to open and close the port(s) 18.

For instance, in one embodiment depicted by FIG. 9, the restraint(s) 20 comprises at least one selectively removable plug 20a corresponding to the at least one port 18. It is envisioned that multiple ports 18 will have an equal number of plugs 20a. The plug 20a may be fabricated from a variety of materials, including plastic, vinyl, rubber or another equally suitable material capable of repeated insertion and removal from the port 18. The plug 20a may be tethered to the toothbrush 10 via a lanyard 40 or other similar device.

In another envisioned embodiment depicted by FIG. 10 through FIG. 12, the restraint(s) 20 comprises at least one selectively openable restraint 20 to open and close the at least one port 18, in which the restraint(s) 20 may comprise a movable element 20b. The movable element 20b may comprises at least two different configurations, including those depicted in FIG. 10 through FIG. 12, respectively. The restraint(s) 20 disclosed herein are envisioned as capable of placement so that the restraint(s) 20 obstruct the port(s) 18 from the top of the port(s) 18, through the middle, or at the lower end of the port(s) 18. Thus, the restraint(s) 20 may be wholly or partially exposed (especially if positioned along the top of the port(s) 18 and/or head 12), or partially exposed and partially contained within the framework of the head 12 and/or stem 14, such as having a slot or opening formed along one side of the head 12 and/or stem 14 so that a portion of the restraint(s) 20 is inserted and is housed therein.

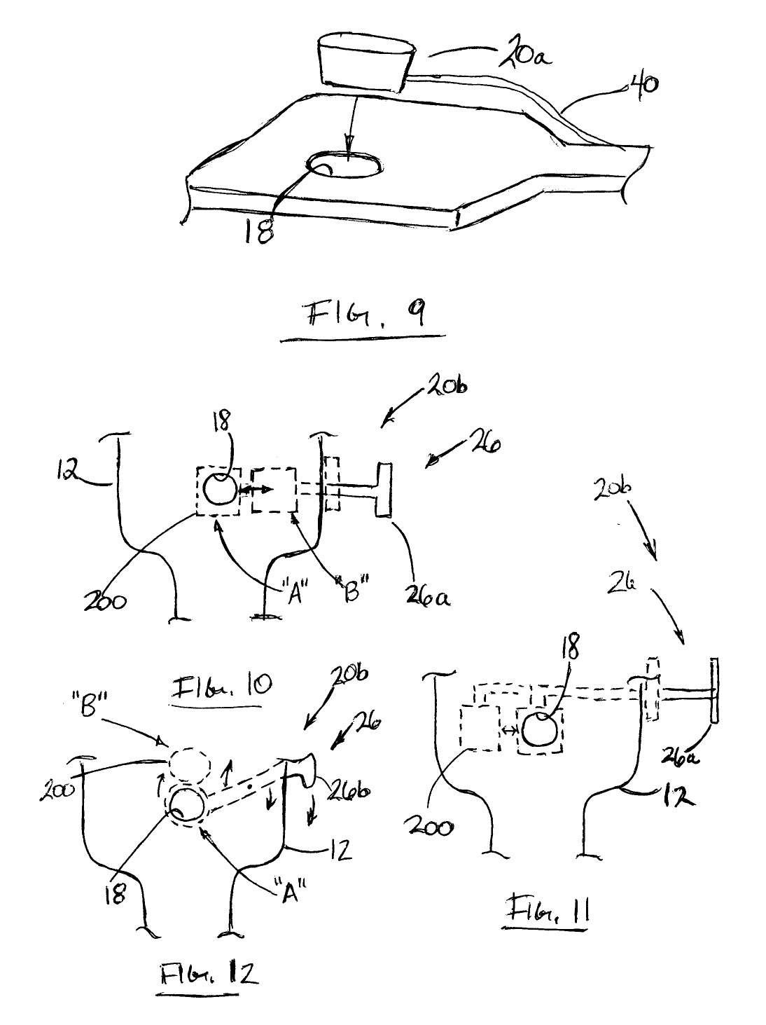

For instance, and as depicted in FIG. 10 and FIG. 11, the movable element 20b comprises a body 200 coupled to a returnably resilient means 26, such as a push or pull button 26a or a wing 26b or other suitable apparatus or device for urging the body 200, in which the body 200 is movable in response to engagement of means 26, particularly through mechanical manipulation by the user. In this manner, means 26 communicates with the body 200 and urges movement thereof accordingly. The body 200 covers the port(s) 18 at a first position “A” of means 26, and the body uncovers or exposes the port(s) 18 at a second position “B” of means 26. Means 26 is biased to return to the first position “A” as a default position so that the port(s) 18 remain covered and the toothpaste is not unnecessarily exposed to air and contaminants, and to preserve the freshness and quality of the toothpaste contained therein.

It is envisioned that the button 26a embodiment and the wing 26b embodiment may be altered so as to accommodate the use of either in embodiments utilizing multiple ports 18. For instance, the button 26a embodiment may provide a single button 26a coupled to multiple bodies 200 associated with multiple ports 18, so that when the button 26a is depressed or retracted, each body 200 is moved and uncovers or exposes the underlying port 18. Similarly, the wing 26b embodiment may provide a single wing 26b coupled to multiple bodies associated with multiple ports 18, so that when the wing 26b is urged forward or backward (either is suitable), each body 200 is moved and uncovers or exposes the underlying port 18. It is similarly envisioned that multiple push buttons 26a, or alternatively, multiple wings 26b, may be utilized to achieve similar functions, and may provide more user choice (if so desired).

It is also envisioned that springs or spring-like devices may be utilized in combination with means 26 to provide the bias necessary to return means 26 to the first (default) position “A” and allow the body(ies) 200 to cover the port(s) 18.

In another envisioned embodiment of the movable element 20b, depicted by FIG. 6, the movable element 20b comprises a slidable element 300. The slidable element 300 comprises a body 302 engaging a shield 304, the body 302 slidably movable within the shield 304 between a first position “A” and a second position “B”. The body 302 covers the port(s) 18 at the first position “A”, and the body uncovers or exposes the port(s) 18 at the second position “B”. The body 302 may further comprise means 306 for slidably moving the body, with means 306 positioned along a top surface of the body 302. Means 306 may include a raised portion, an indentation, a textured portion, a separate element or device coupled to the body 302, or other suitable apparatuses and/or devices for aiding in moving the slidable element 300. The shield 304 may further comprise at least one detente 308 (or a plurality of detentes as depicted in FIG. 6) to inhibit the slidable element 302 from escaping the shield 304. Another embodiment is depicted in FIG. 8, in which the body 302 is slidably movable within a track 310, with a guide or other similar apparatus depending from the body 302 and engaging and sliding within the track 310 provided.

As depicted in FIG. 3, it is envisioned that the stem 14 may comprise an ergonomic grip 32, if so desired. In this embodiment, the grip 32 has a plurality of raised or contoured surfaces to enhance the user's grip and provide comfort during usage.

The stem 14 comprises an opening 22 formed at an end opposite to the head 12 of the toothbrush 10. The opening 22 provides direct fluid communication with the channel 24 that longitudinally extends from the opening 22 to the port(s) 18. The opening 22 may have a variety of configurations and/or forms, including the embodiments depicted in FIG. 1 and FIG. 2, respectively.

For instance, and as depicted in FIG. 1, the opening 22 comprises internal threads 28 formed on the interior circumferential surface 220 of the opening 22, the internal threads 28 being complementary to the external threads 106 formed on the neck 102 of the tube 100 of toothpaste. Therefore, the cap of a commercially available tube 100 of toothpaste may be removed, and then the neck 102 (and external threads 106) threadably coupled to the internal threads 28 of the opening 22. As a result, the tube 100 is operatively coupled to the toothbrush 10, and the neck 102 and opening 104 of the tube 100 are in fluid communication with the opening 22 and the channel 24 within the toothbrush 10.

In another embodiment of the opening 22, depicted in FIG. 2, the opening 22 comprises a returnably resilient perimeter 30 coupled to the neck 102 of the tube 100 of toothpaste. The perimeter 30 may be integrally formed with the threads 28 of opening 22, or may be a separate device coupled thereto. The perimeter 30 is envisioned as being fabricated from a flexible and returnably resilient material, such as soft plastic, vinyl or rubber, thereby providing the elasticity in the composition of the material so that the perimeter may be forced onto the neck 102 of the tube 100 of toothpaste. In this manner, the opening 22 (and the perimeter 30 more particularly) is coupled to the neck 102 of the tube 100 of toothpaste by frictional impingement.

As depicted in FIG. 4, FIG. 5 and FIG. 7, the channel 24 may have a variety of diameters and cross-sectional configurations and/or forms. The channel 24 may be configured to encompass a substantial area within the toothbrush 10, and especially the stem 14 and what may be considered the neck of the toothbrush (as a transition between the stem 14 and head 12). Similarly, the channel 24 may be configured to consume as little area as necessary. In the former configuration, some material costs may be saved by reducing the amount of material necessary to construct the stem 14 and channel 24 therein. In the latter configuration, the emphasis may be on limiting the amount of toothpaste forced into the channel 24 that must be stored until the toothbrush 10 is utilized again, thereby reducing the likelihood of the toothpaste drying. Furthermore, with a smaller channel 24, the force necessary to extrude toothpaste through the port(s) 18 is reduced, thereby aiding small children, weak adults and the elderly with dispensing of toothpaste therethrough.

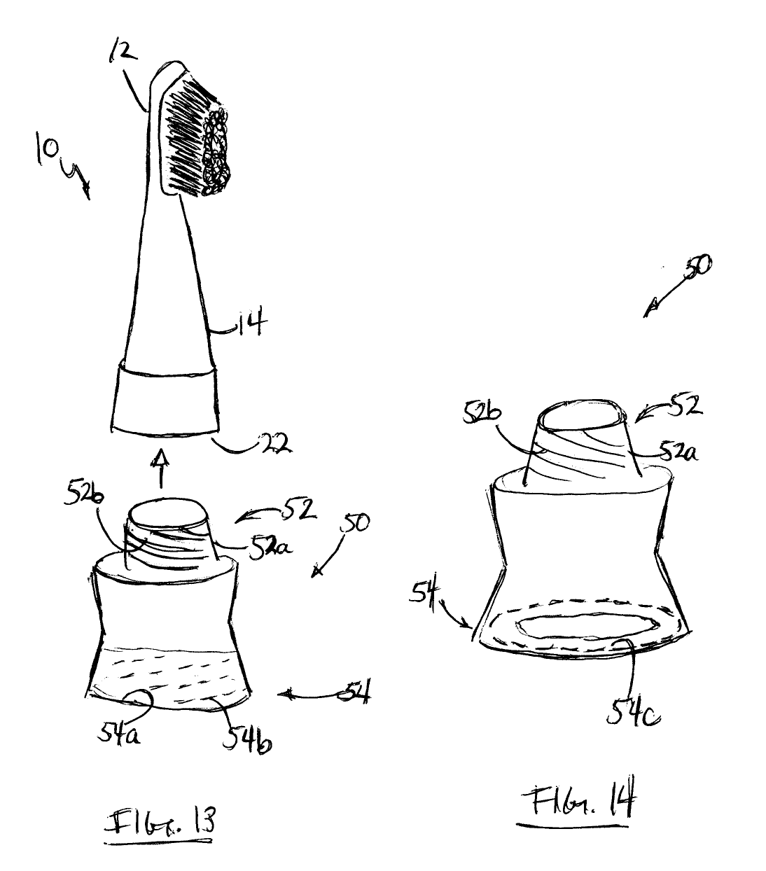

Referring now to FIG. 13 and FIG. 14, the toothbrush 10 may further comprise an adapter 50, wherein the adapter 50 comprises an end 52 coupled to the opening 22 and an opposing end 54 coupled to the neck 102 of the tube 100 of toothpaste. The adapter 50 is described and depicted as having two general forms, although other forms are envisioned. The adapter 50 is envisioned as having function with the toothbrush 10 because toothpaste tubes have necks with one of two dimensions or sizes. In other words, toothpaste tube manufacturers produce tubes having one dimension/size or the an alternative dimension/size. Thus, one dimension/size would be accommodated by the opening 22 in the stem 14, while the adapter 50 and its opposing end 54 would accommodate the alternative dimension or size, thereby providing dimension/size coverage for most, if not all, of the toothpaste tube necks commercially available.

For instance, and as depicted in FIG. 13, the end 52 of the adapter 50 comprises external threads 52b formed on the exterior circumferential surface 52a of the end 52, the threads 52b complementary to internal threads 28 formed in the opening 22. The opposing end 54 of the adapter 50 comprises internal threads 54b formed on the interior circumferential surface 54a of the opposing end 54 complementary to the external threads 106 formed on the neck 102 of the tube 100 of toothpaste.

In another embodiment, depicted in FIG. 14, the end 52 of the adapter 50 comprises external threads 52b formed on the exterior circumferential surface 52a of the end 52 complementary to internal threads 28 formed in the opening 22. The opposing end 54 of the adapter 50 comprises a returnably resilient perimeter 54c integrally formed or as a separete apparatus coupled to the neck 102 of the tube 100 of toothpaste.

It is envisioned that the aforementioned embodiments, in whole or in part, may be applicable in forming an apparatus or device in combination with many varieties of toothbrushes presently available, including standard manual toothbrushes and the electrically powered toothbrushes presently popular with dentists and users. Thus, the examples provided above should not be viewed or characterized as limitations to standard or conventional manual toothbrushes, but instead, as equally applicable to electrical and other forms of toothbrushes.

What is claimed is:

1. A toothbrush coupled to a tube of toothpaste, the toothbrush comprising:
a head depending from an elongated stem;
the head comprising a plurality of bristles and at least one toothpaste dispensing port;
at least one restraint to open and close the at least one port; and
the stem comprising an opening coupled to the tube, the stem further comprising a channel extending from the opening to the at least one port.

2. The toothbrush of claim 1, wherein the restraint comprises at least one plug.

3. The toothbrush of claim 1, wherein the opening comprises internal threads formed on the interior circumferential surface thereof complementary to the external threads formed on the neck of the tube of toothpaste.

4. The toothbrush of claim 1, wherein the opening comprises a returnably resilient perimeter coupled to the neck of the tube of toothpaste.

5. The toothbrush of claim 4, wherein the opening is coupled to the neck of the tube of toothpaste by impingement.

6. The toothbrush of claim 1, wherein the stem comprises an ergonomic grip.

7. The toothbrush of claim 1 further comprising an adapter, the adapter comprising an end coupled to the opening and an opposing end coupled to the neck of the tube of toothpaste.

8. The toothbrush of claim 7, wherein the end of the adapter comprises external threads formed on the exterior circumferential surface thereof complementary to internal threads formed in the opening, and wherein the opposing end of the adapter comprises internal threads formed on the interior circumferential surface thereof complementary to the external threads formed on the neck of the tube of toothpaste.

9. The toothbrush of claim 7, wherein the end of the adapter comprises external threads formed on the exterior circumferential surface thereof complementary to internal threads formed in the opening, and wherein the opposing end of the adapter comprises a returnably resilient perimeter coupled to the neck of the tube of toothpaste.

10. A toothbrush coupled to a tube of toothpaste, the toothbrush comprising:
a head depending from an elongated stem;
the head comprising a plurality of bristles and at least one toothpaste dispensing port;
at least one selectively openable restraint to open and close the at least one port;
the stem comprising an opening coupled to the tube, the stem further comprising a channel extending from the opening to the at least one port.

11. The toothbrush of claim 10, wherein the restraint comprises a movable element.

12. The toothbrush of claim 11 wherein the movable element comprises:
a body coupled to a button, the body movable in response to engagement of the button;
the body covering the port at a first position of the button, and the body uncovering the port at a second position; and
the button biased to return to the first position.

13. The toothbrush of claim 11, wherein the movable element comprises a slidable element.

14. The toothbrush of claim 13, wherein the slidable element comprises:
a body engaging a track, the body slidably movable along the track between a first position and a second position; and
the body covering the port at the first position, and the body uncovering the port at the second position.

15. The toothbrush of claim 14, wherein the body further comprises means for slidably moving the body.

16. The toothbrush of claim 10, wherein the opening comprises internal threads formed on the interior circumferential surface thereof complementary to the external threads formed on the neck of the tube of toothpaste.

17. The toothbrush of claim 10, wherein the opening comprises a returnably resilient perimeter coupled to the neck of the tube of toothpaste.

18. The toothbrush of claim 17, wherein the opening is coupled to the neck of the tube of toothpaste by impingement.

19. The toothbrush of claim 10, wherein the stem comprises an ergonomic grip.

20. The toothbrush of claim 10 further comprising an adapter, the adapter comprising an end coupled to the opening and an opposing end coupled to the neck of the tube of toothpaste.

21. The toothbrush of claim 20, wherein the end of the adapter comprises external threads formed on the exterior circumferential surface thereof complementary to internal threads formed in the opening, and wherein the opposing end of the adapter comprises internal threads formed on the interior circumferential surface thereof complementary to the external threads formed on the neck of the tube of toothpaste.

22. The toothbrush of claim 20, wherein the end of the adapter comprises external threads formed on the exterior circumferential surface thereof complementary to internal threads formed in the opening, and wherein the opposing end of the adapter comprises a returnably resilient perimeter coupled to the neck of the tube of toothpaste.

23. A toothbrush kit comprising:
at least one tube of toothpaste and a toothbrush, the toothbrush comprising;
a head depending from an elongated stem;
the head comprising a plurality of bristles and at least one toothpaste dispensing port;
at least one (removable) restraint to open and close the at least one port; and
the stem comprising an opening coupled to the tube of toothpaste, the stem further comprising a channel extending from the opening to the at least one port.

24. The kit of claim 23, wherein the restraint comprises at least one plug.

25. The kit of claim 23, wherein the restraint comprises a movable element.

26. The kit of claim 25, wherein the movable element comprises:
a body coupled to a button, the body movable in response to engagement of the button;
the body covering the port at a first position of the push button, and the body uncovering the port at a second position; and
the button biased to return to the first position.

27. The kit of claim 25, wherein the movable element comprises a slidable element.

28. The kit of claim 27, wherein the slidable element comprises:
a body engaging a track, the body slidably movable along the track between a first position and a second position; and
the body covering the port at the first position, and the body uncovering the port at the second position.

29. The kit of claim 28, wherein the body further comprises means for slidably moving the body.

30. The kit of claim 23, wherein the opening comprises internal threads formed on the interior circumferential surface thereof complementary to the external threads formed on the neck of the tube of toothpaste.

31. The kit of claim 23, wherein the opening comprises a returnably resilient perimeter coupled to the neck of the tube of toothpaste.

32. The kit of claim 31, wherein the opening is coupled to the neck by impingement.

33. The kit of claim 23 further comprising an adapter, the adapter comprising an end coupled to the opening and an opposing end coupled to the neck of the tube of toothpaste.

34. The kit of claim 33, wherein the end of the adapter comprises external threads formed on the exterior circumferential surface thereof complementary to internal threads formed in the opening, and wherein the opposing end of the adapter comprises internal threads formed on the interior circumferential surface thereof complementary to the external threads formed on the neck of the tube of toothpaste.

35. The kit of claim 33, wherein the end of the adapter comprises external threads formed on the exterior circumferential surface thereof complementary to internal threads formed in the opening, and wherein the opposing end of the adapter comprises a returnably resilient perimeter coupled to the neck of the tube of toothpaste.
